(19) United States
(12) Patent Application Publication
(10) Pub. No.: US 2008/0222834 A1
(43) Pub. Date: Sep. 18, 2008

(54) WIPER

(75) Inventor: Satoshi Komori, Niwa-Gun (JP)

Correspondence Address: BURR & BROWN, PO BOX 7068, SYRACUSE, NY, 13261-7068, US

(73) Assignee: Okuma Corporation, Niwa-Gun (JP)

(21) Appl. No.: 12/039,780

(22) Filed: Feb. 29, 2008

(30) Foreign Application Priority Data
Mar. 15, 2007 (JP) 2007-067316

(51) Int. Cl. B60S 1/34

(52) U.S. Cl. 15/250.351

(57) ABSTRACT

A wiper 1 for a machine tool which has two covers includes: a main body having an attachment part 4 to attach the wiper to a fixing cover and a tongue part 5 extended from the attachment part 4 in a tilted direction with respect to a sliding surface of the fixing cover L; and a metal plate 3 mounted on the tongue part 5, wherein the tongue part 5 is located along a substantially entire face of the metal plate 3 which faces to the sliding surface of the cover L, and a thin wall part 5a of a tip end of the tongue part 5 and a tip end of the metal plate 3 are brought into contact with the sliding surface of the cover L to cover a gap between the sliding surface of the cover L and the other cover.

This application claims the benefit of Japanese Patent Application Number 2007-067316 filed on Mar. 15, 2007, the entirety of which is incorporated by reference.

### BACKGROUND OF THE INVENTION

1. Field of the Invention

The present invention relates to a wiper for a machine tool being attached so as to cover a gap between surfaces of covers installed in the tool which move relative to each other, and prevents chips and cutting liquid from entering the gap.

2. Description of the Background Art

Conventionally a machine tool has a wiper so as to cover a gap between surfaces of a moving cover mounted on a saddle side moving in an axial direction of a main spindle of a lathe and a fixing cover mounted on a headstock side, in order to prevent chips, cutting liquid and the like from entering the gap. As a wiper material, rubber has been used. Since the rubber wiper comes into better contact with a sliding surface of the cover, it has an advantage of high wiping effects and excellent following of small irregularities on the sliding surface of the cover. However, when a rubber is used as a material of the wiper, sliding resistance becomes large and alignment accuracy is easily affected. Further, as friction of a contacting part with the sliding surface of the cover becomes large as well, biting often occurs and the rubber wiper is easily damaged by the chips and the like. Therefore, a wiping function is likely to be impaired.

For this reason, a thin metal plate is used as a wiper material instead of rubber. Patent Documents 1 to 3 disclose that a thin metal plate is used so as to contact with the sliding surface of the cove as a wiper.

[Patent document 1] Japanese Unexamined Patent Publication No. 1996-85039

[Patent document 2] Japanese patent No. 3863556

[Patent document 3] Japanese Unexamined Utility Model Publication No. 1991-19653

Patent document 1 discloses a wiper including a thin metal plate mounted on a rubber main body of the wiper, and is configured that a tip end part of the metal plate comes into contact with the sliding surface of the cover to fulfill the wiping function.

Patent document 2 discloses a wiper including a thin metal plate mounted on a surface of a rubber main body which faces to the cover, and is configured that only a tip end part of the metal plate comes into contact with the sliding surface of the cover to fulfill the wiping function.

Patent document 3 discloses a double-structured wiper where a rubber wiper body and a wiper body made of a thin metal plate are independently provided, and tip end parts of the respective wiper bodies are brought into contact with the sliding surface of the cover.

### SUMMARY OF THE INVENTION

However, in the wipers disclosed in Patent documents 1 and 3, the metal plate may be damaged or deformed due to collision of chips and the like, and thereby the sliding surface of the cover may be damaged. Further, contact pressure of a contacting part of the tip end of the metal plate on the sliding surface of the cover may increase, and therefore the sliding surface of the cover may be damaged. Further, as compared with the rubber wiper, a gap is likely to be produced with the sliding surface of the cover, resulting in poor wiping effect, poor followability to the small irregularities in the sliding surface of the cover.

On the other hand, a wiper disclosed in Patent document 2 where only tip end of a metal plate is brought into contact with a sliding surface of the cover, the contact pressure on the sliding surface of the cover increases, similarly to the wipers disclosed in Patent documents 1 and 3. Therefore the sliding surface of the cover may be damaged as well.

Considering the above problems, an object of the present invention is to provide a wiper where a metal plate is used being capable of preventing the metal plate from being deformed and to fulfill high wiping effect without causing any damages of the sliding surface of the cover.

In order to accomplish the above object, a first aspect of the present invention is a wiper for machine tools mounted on a first face so as to cover a gap between the first face and a second face which is moving relative to the first face, and preventing chips, cutting liquid and the like from entering the gap. The wiper includes: a main body having an attachment part to attach the wiper to the machine tool and a tongue part extended from the attachment part in a tilted direction with respect to the second face; and a metal plate mounted on the tongue part, wherein the tongue part is located along a substantially entire face of a side of the metal plate which faces to the second face, and a tip end of the tongue part and a tip end of the metal plate are brought into contact with the second face to cover the gap.

In the present invention, the metal plate is mounted on the tongue part so that the tongue part is located along the substantially entire face of one side of the metal plate which faces to the second face. In this configuration, the substantially entire face of the metal plate is supported by the rubber main body so that the metal plate is unlikely to be deformed or damaged, even if the chips and the like collide with the metal plate. Therefore, the second face is not likely damaged and durability of the wiper increases.

Further, as the tongue part is located along the face of the metal plate which faces to the second face, chips generated in a cutting space do not collide with the tongue part. Therefore, the tongue part is unlikely to be damaged, and the life of the wiper can be further extended.

Still further, since the tip end of the tongue part and the tip end of the metal plate are brought into contact with the second face, the contact pressure of a tip end part of the wiper, particularly contact pressure of the metal plate on the second face is reduced. As a result, the second face would not be damaged, and excessive wearing of the tip end part of the tongue part can be inhibited. Thus, the durability of the wiper is increased, as compared with a case where only the metal plate is brought into contact with the second face as shown in Patent Document 2.

### BRIEF DESCRIPTION OF THE DRAWINGS

FIG. 1 is an explanatory diagram illustrating a machine tool installed with a wiper;

FIG. 2 is a cross-sectional explanatory diagram illustrating the wiper; and

FIG. 3 is a cross-sectional explanatory diagram illustrating a wiper as a modified example.

### DESCRIPTION OF THE PREFERRED EMBODIMENTS

A wiper according to one embodiment of the present invention will be hereinafter described on the basis of the drawings.

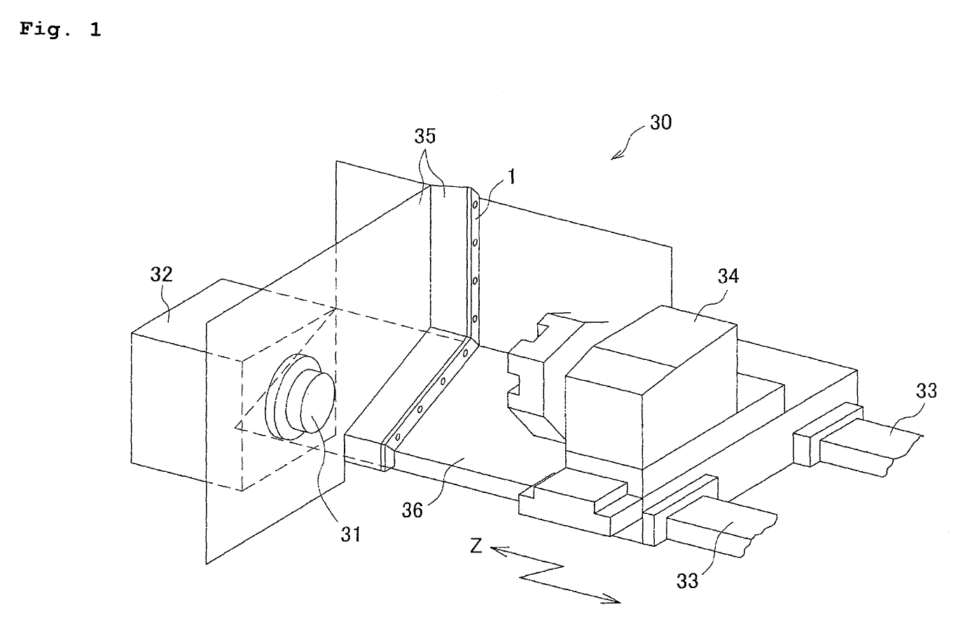

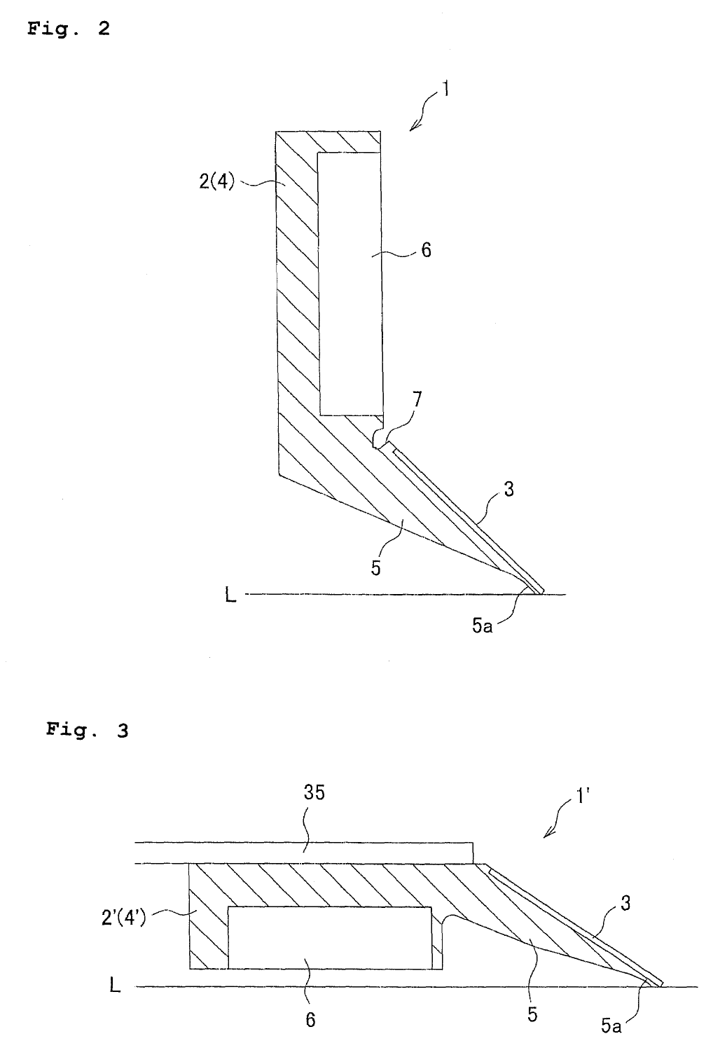

FIG. 1 is an explanatory diagram illustrating a machine tool 30 installed with a wiper 1, and FIG. 2 is a cross-sectional explanatory diagram illustrating the wiper 1.

The machine tool 30 is a lathe including: a headstock 32 that is fixed to a bed (not shown) and rotatably supports a main spindle 31; and a tool rest 34 mounted movably on guide rails 33 and 33 in an axial direction of the main spindle 31. In the machine tool 30, a fixing cover (a first face) 35 is installed in the headstock 32, whereas moving cover (a second face) 36 is installed in a tool rest 34. The moving cover 36 is moving along with the tool rest 34, and both covers 35, 36 prevent chips, cutting liquid and the like from gathering on upper faces of the guide rails 33 and 33. Further, the chips and the like are prevented from being scattered outside a cutting space. On a side end face of the fixing cover 35, which faces to the moving cover 36, the wiper 1 is installed so as to cover the gap between the fixing cover 35 and the moving cover 36 and prevents the chips, cutting liquid and the like from entering the gap.

The wiper 1 includes a rubber main body 2 and a metal plate 3 which is mounted on the main body 2. The main body 2 and the metal plate 3 are molded in a strip shape mountable along the end face of the fixing cover 35.

The main body 2 includes: a cross-sectionally rectangular-shaped attachment part 4 for attaching thereof to the fixing cover 35; and a tongue part 5 vertically extended downward from the mounting part 4, which are by integrally molded. At the central part of the attachment part 4, a groove-shaped concave part 6 is longitudinally provided for mounting a core member for reinforcement. Further, the tongue part 5 is configured so as to be bent with respect to the attachment part 4 and gradually thinned toward a lower end thereof that is a tip end part on a contacting side. At the lower tip end of the tongue part, a thin wall part 5a having a predetermined width is formed. Further, a tip end face of the thin wall part 5a is formed so as to be a tilted face being parallel to a sliding surface of the cover L, an upper face of the moving cover 36 in the present embodiment, when the main body 2 is attached to the fixing cover 35. As a result, a contact area between the tip end face and the sliding surface of the cover is made as large as possible. In addition, reference numeral 7 represents a groove part provided on an upper face of a base end part of the tongue part 5.

On the other hand, the metal plate 3 is made of a thin metal plate member such as a spring steel plate, and mounted on an upper face of the tongue part 5. The tongue part 5 is located along one of the side faces of the metal plate 3 which faces to the sliding surface of the cover L. Further, the metal plate 3 is mounted in a state where a substantially entire mounting face thereof is supported by the main body 2 such that a tip end of the metal plate 3 comes into contact with the sliding surface of the cover L. In other words, the tip end of the metal plate is located in the same plane as the tip end face of the thin wall part 5a.

The wiper 1 having the above configuration is installed on the end face of the fixing cover 35 by being screwed or the like in a state where the tip end face of the thin wall part 5a and the tip end of the metal plate 3 are brought into contact with the sliding surface of the cover L. It relatively slides on the sliding surface of the cover L in response to movement of the moving cover 36, to thereby prevent the chips, cutting liquid and the like from gathering on the sliding surface of the cover L and from entering the gap between the fixing cover 35 and the moving cover 36.

According to the wiper 1 having the configuration described above, the metal plate 3 is unlikely to be deformed or damaged even if the chips and the like collide with the metal plate 3 because the substantially entire mounting face of the metal plate 3 is supported by the rubber main body 2. Therefore, the sliding surface of the cover L can be prevented from being damaged. Further, as the metal plate 3 is not easily deformed, so that the wiper 1 can be used over a long period of time without impairing the wiping function.

Further, the chips generated in the cutting space can be prevented from colliding with the tongue part 5, because the tongue part 5 is located along the face of the metal plate 3, which faces to the sliding surface of the cover L. As a result, the tongue part 5 is unlikely to be damaged, and the life of the wiper 1 can be further extended.

Still further, the tip end face of the tongue part 5 is provided so as to be parallel to the sliding surface of the cover L, and the tip end face of the tongue 5 and the tip end of the metal plate 3 are brought into contact with the sliding surface of the cover L. When the wiper 1 is used as in this state, the contact pressure of the tip end part of the wiper 1, particularly contact pressure of the metal plate 3 on the sliding surface of the cover L, can be reduced, and therefore damages on the sliding surface of the cover L can be further prevented, as compared with a case where only the metal plate is brought into contact with it.

Moreover, the contact pressure of the wiper 1 is reduced which results that the thin wall part 5a can be inhibited from excessively wearing. Consequently the life of the wiper 1 can be further extended.

In addition, the configuration pertaining to the wiper of the present invention is not limited to any aspect described in the above embodiment, and the configurations of the main body and the metal plate may be appropriately modified without departing from the scope of the present invention.

For example, the wiper is installed as as to cover the gap between the fixing cover and the moving cover in the above embodiment; however, it is obviously possible to install the wiper to cover a gap between two moving covers that move relatively to each other. Further, in the above embodiment, the wiper is provided so as to cover the gap with the moving cover that moves in a crossing direction with respect to the fixing cover; however, the present invention may be applied so as to cover a gap with a moving cover that moves in a parallel direction orthogonal to the crossing direction, or may be applied so as to cover a gap between two moving covers that move in a parallel direction.

Furthermore, as illustrated in FIG. 3, the wiper may be configured so as to be installed to a face opposing to the sliding surface L at an end part of the cover. FIG. 3 is a cross-sectional explanatory diagram illustrating a wiper 1′ as a modified example. The wiper 1′ is configured where a tongue part 5 is vertically extended downward from a side part of an attachment part 4′, differently from the wiper 1. The wiper 1 can also produce the same effects as those of the above described wiper 1, such as long term durability without any deformation of the metal plate 3 and damages of the sliding surface of the cover L. It should be noted that in the wiper 1 illustrated in FIG. 3, the same components as those of the wiper 1 illustrated in FIG. 2 are represented by the same reference symbols. A configuration pertaining to mounting of the metal plate 3 to the tongue part 5 is also the same as that of the wiper 1.

What is claimed is:

1. A wiper of a machine tool where two faces moving relatively are installed comprising:
a main body including an attachment part for attaching the wiper to a first face and a tongue part extended from the attachment part in a tilted direction with respect to a second face; and
a metal plate mounted on the tongue part, wherein
the tongue part is located along a substantially entire face of the metal plate, which faces to the second face, and a tip end of the tongue part and a tip end of the metal plate are brought into contact with the second face to cover a gap between the first face and the second face to prevent chips, cutting liquid and the like from entering thereto.

2. The wiper according to claim 1, wherein the tip end of the tongue part is provided so as to be thin.
